(19) United States
(12) Patent Application Publication
(10) Pub. No.: US 2021/0295614 A1
(43) Pub. Date: Sep. 23, 2021

(54) SYSTEM AND METHOD FOR FILTERLESS THROTTLING OF VEHICLE EVENT DATA

(71) Applicant: Wejo Ltd., Manchester (GB)

(72) Inventor: Christopher Andrew Camplejohn, Mold (GB)

(73) Assignee: Wejo Ltd., Manchester (GB)

(21) Appl. No.: 17/206,868

(22) Filed: Mar. 19, 2021

Related U.S. Application Data
(60) Provisional application No. 62/991,970, filed on Mar. 19, 2020.

(51) Int. Cl. G07C 5/08; G07C 5/00; G06F 16/22; G06F 16/23; G06F 16/25

(52) U.S. Cl. CPC G07C 5/085; G07C 5/008; G06F 16/254; G06F 16/2365; G06F 16/2255

(57) ABSTRACT

Embodiments are directed to a system and methods for filterless throttling of vehicle event data via an Egress portal.

### CROSS REFERENCE TO RELATED APPLICATIONS

The present application claims priority to U.S. Prov. Pat. App. No. 62/991,970 having a filing date of Mar. 19, 2020, the entirety of which is incorporated by reference herein.

### BACKGROUND OF THE DISCLOSURE

The automotive industry is undergoing a radical change unlike anything seen before. Disruption is happening across the whole of the mobility ecosystem. The result is vehicles that are more automated, connected, electrified and shared. This gives rise to an explosion of car generated data. This rich new data asset remains largely untapped.

Vehicle location event data, such as GPS data, is extremely voluminous and can involve 200,000-600,000 records per second. The processing of location event data presents a challenge for conventional systems to provide substantially real-time analysis of the data, especially for individual vehicles. In particular, end user technology can require data packages What is needed are system platforms and data processing algorithms and processes configured to process high-volume data with low latency.

While there are systems for tracking vehicles, what is needed is virtually real-time and accurate trip and road information from high-volume vehicle data. What is needed is systems and algorithms configured to process high volume movement and route analysis with low-latency.

### SUMMARY

The following briefly describes embodiments in order to provide a basic understanding of some aspects of the innovations described herein. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments of a system, method, and computer program product for processing vehicle event data.

An implementation is a system comprising a non-transitory memory including program instructions and a processor configured to execute instructions to at least: ingress via an ingress server, an ingressed datastream of vehicle event data including movement data for a plurality of vehicles; assign a plurality of Vehicle Identifiers to a plurality of respective vehicle records for the plurality of vehicles of the vehicle event data; and egress, a throttled datastream of the vehicle records to a client device via an egress server with a filterless throttling algorithm configured to sort a portion of the vehicle records identified from the ingressed datastream to be egressed to the client device into a plurality of Bucket files and delete the vehicle records from the egress server that are not sorted to the plurality of Bucket files.

The system comprises a data storage configured to store vehicle event data, and a filterless throttling algorithm that is configured to at least: obtain a Total Vehicles number by determining a total number of vehicles of the vehicle event data stored by the system for a predetermined time period; identify a Total Buckets number for the total number of Bucket files to sort a portion of the vehicle records from the vehicle event data to be egressed to the external client device; calculate a Vehicles Per Bucket by dividing the Total Vehicles number by Total Buckets number; calculate a Vehicle Target number for the number of vehicle records to be egressed to the external client device; calculate a Required Buckets by dividing the Vehicle Target number by the Vehicles Per Bucket number; calculate a Vehicle Identifier Hash by hashing the Vehicle Identifier to a positive number; calculate a Vehicle Bucket number by taking a Modulus of the Vehicle Identifier Hash by the Total Buckets number; and if the Vehicle Bucket number is less than or equal to the Required Buckets number, include the vehicle record for the identified vehicle in the Vehicle Bucket file and egress the vehicle record via an egress server to the client device; or if the Vehicle Bucket number is greater than the Required Buckets number, delete the vehicle record from the Egress Server. The filterless throttling algorithm can further be configured to at least: calculate a Vehicle Target by calculating and adding a Minimum Additional Percentage of vehicles to the Total Vehicles.

In an implementation, the filterless throttling algorithm is further configured to at least: periodically recalculate the Vehicle Bucket to adjust for fluctuating volumes of vehicles identified from the vehicle event data. The recalculating comprises: recalculating the Vehicles per Bucket; recalculating the Vehicle Target; and recalculating the Vehicle Bucket. The filterless throttling algorithm can further be configured to at least: precalculate the Vehicle Bucket for the vehicle event record, the precalculating comprising: precalculating the Vehicles per Bucket; precalculating the Vehicle Target; and precalculating the Vehicle Bucket.

In an implementation, the filterless throttling algorithm is configured to calculate the hash with a partition algorithm.

In an implementation, the filterless throttling algorithm is configured to throttle the throttled datastream based on the external client system requirements. The egress server is configured to throttle the throttled datastream for stream delivery, batch delivery, or both.

An embodiment is a method to be executed on a system comprising a non-transitory memory including program instructions and a processor configured to execute instructions described above and herein.

At least one embodiment is a computer program product including program memory including instructions which, when executed by processor, executes the methods described above and herein.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of an environment in which at least one of the various embodiments can be implemented.

FIG. 2 shows a logical architecture and flowchart for an Ingress Server system in accordance with at least one of the various embodiments of the present disclosure.

FIG. 3 shows a logical architecture and flowchart for a Stream Processing Server system in accordance with at least one of the various embodiments.

FIG. 4A represent a logical architecture and flowchart for an Egress Server system in accordance with at least one of the various embodiments;

FIG. 4B shows a process for throttling vehicle event data.

FIG. 5 illustrates a logical architecture and flowchart for a process for an Analytics Server system in accordance with at least one of the various embodiments.

FIG. 6 illustrates a logical architecture and flowchart for a process for a Portal Server system in accordance with at least one of the various embodiments.

FIG. 7 is a flowchart showing a data quality pipeline of data processing checks for the system.

FIG. 8 illustrates a cloud computing architecture in accordance with at least one of the various embodiments.

FIG. 9 illustrates a logical architecture for cloud computing platform in accordance with at least one of the various embodiments.

### DETAILED DESCRIPTION OF THE EMBODIMENTS

Various embodiments now will be described more fully hereinafter with reference to the accompanying drawings, which form a part hereof, and which show, by way of illustration, specific embodiments by which the innovations described herein can be practiced. The embodiments can, however, be embodied in many different forms and should not be construed as limited to the embodiments set forth herein. Rather, these embodiments are provided so that this disclosure will be thorough and complete, and will fully convey the scope of the embodiments to those skilled in the art. Among other things, the various embodiments can be methods, systems, media, or devices. Accordingly, the various embodiments can take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in one embodiment” or “in an embodiment” as used herein does not necessarily refer to the same embodiment or a single embedment, though it can. Furthermore, the phrase “in another embodiment” as used herein does not necessarily refer to a different embodiment, although it can. Thus, as described below, various embodiments can be readily combined, without departing from the scope or spirit of the invention.

In addition, as used herein, the term “or” is an inclusive “or” operator, and is equivalent to the term “and/or” unless the context clearly dictates otherwise. The term “based on” is not exclusive and allows for being based on additional factors not described, unless the context clearly dictates otherwise. In addition, throughout the specification, the meaning of “a” “an” and “the” include plural references. The meaning of “in” includes “in” and “on.”

As used herein, the term “Host” can refer to an individual person, partnership, organization, or corporate entity that can own or operate one or more digital media properties (e.g., web sites, mobile applications, or the like). Hosts can arrange digital media properties to use hyper-local targeting by arranging the property to integrate with widget controllers, content management servers, or content delivery servers.

As used herein, a journey can include any trip, run, or travel to a destination.

### Illustrative Logical System Architecture and System Flows

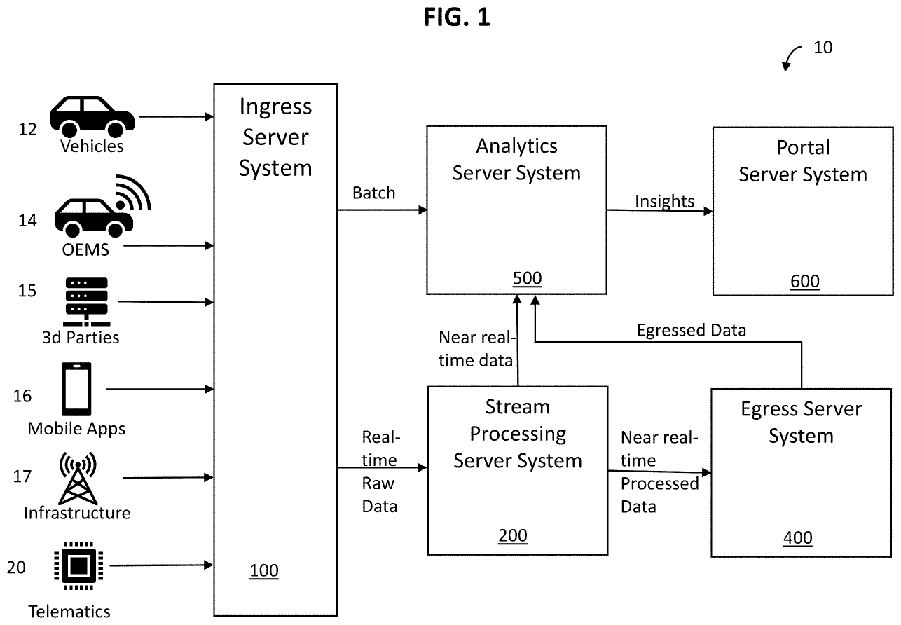

FIG. 1 is a logical architecture of system 10 for geolocation event processing and analytics in accordance with at least one embodiment. In at least one embodiment, Ingress Server system 100 can be arranged to be in communication with Stream Processing Server system 200 and Analytics Server system 500. The Stream Processing Server system 200 can be arranged to be in communication with Egress Server system 400 and Analytics Server system 500.

The Egress Server system 400 can be configured to be in communication with and provide data output to data consumers. The Egress Server system 400 can also be configured to be in communication with the Stream Processing Server 200.

The Analytics Server system 500 is configured to be in communication with and accept data from the Ingress Server system 100, the Stream Processing Server system 200, and the Egress Server system 400. The Analytics Server system 500 is configured to be in communication with and output data to a Portal Server system 600.

In at least one embodiment, Ingress Server system 100, Stream Processing Server system 200, Egress Server system 400, Analytics Server system 500, and Portal Server system 600 can each be one or more computers or servers. In at least one embodiment, one or more of Ingress Server system 100, Stream Processing Server system 200, Egress Server system 400, Analytics Server system 500, and Portal Server system 600 can be configured to operate on a single computer, for example a network server computer, or across multiple computers. For example, in at least one embodiment, the system 10 can be configured to run on a web services platform host such as Amazon Web Services (AWS) or Microsoft Azure. In an exemplary embodiment, the system is configured on an AWS platform employing a Spark Streaming server, which can be configured to perform the data processing as described herein. In an embodiment, the system can be configured to employ a high throughput messaging server, for example, Apache Kafka.

In at least one embodiment, Ingress Server system 100, Stream Processing Server system 200, Egress Server system 400, Analytics Server system 500, and Portal Server system 600 can be arranged to integrate and/or communicate using API's or other communication interfaces provided by the services.

In at least one embodiment, Ingress Server system 100, Stream Processing Server system 200, Egress Server system 400, Analytics Server system 500, and Portal Server system 600 can be hosted on Hosting Servers.

In at least one embodiment, Ingress Server system 100, Stream Processing Server system 200, Egress Server system 400, Analytics Server system 500, and Portal Server system 600 can be arranged to communicate directly or indirectly over a network to the client computers using one or more direct network paths including Wide Access Networks (WAN) or Local Access Networks (LAN).

One of ordinary skill in the art will appreciate that the architecture of system 10 is a non-limiting example that is illustrative of at least a portion of an embodiment. As such, more or less components can be employed and/or arranged differently without departing from the scope of the innovations described herein. However, system 10 is sufficient for disclosing at least the innovations claimed herein.

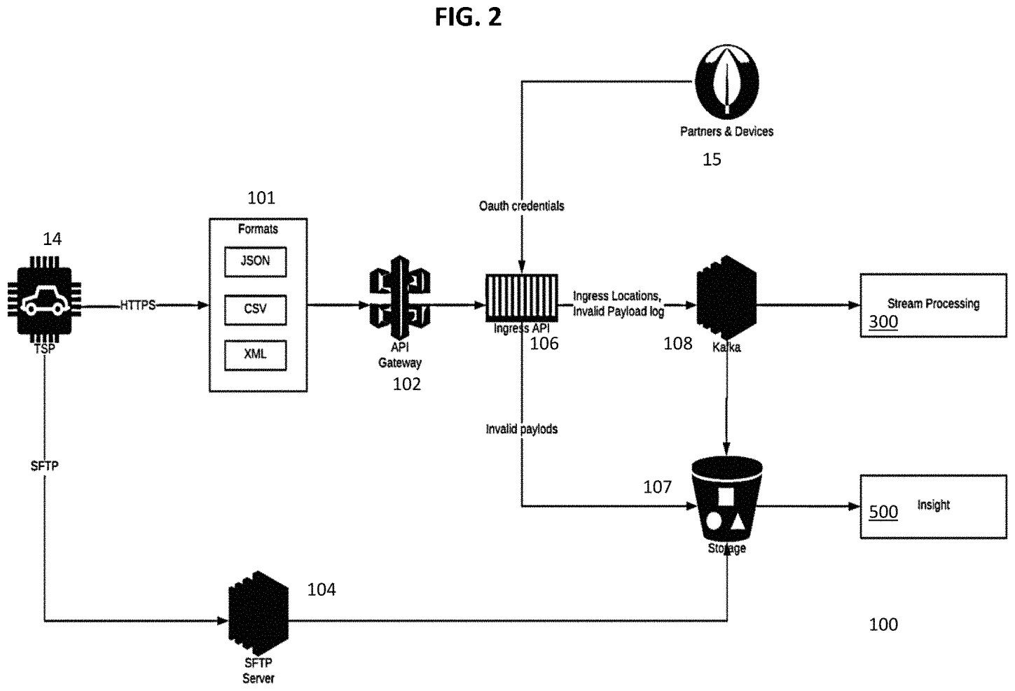

Referring to FIG. 2, a logical architecture for an Ingress Server system 100 for ingesting data and data throughput in accordance with at least one embodiment is shown. In at least one embodiment, events from one or more event sources can be determined. In an embodiment, as shown in FIG. 1, event sources can include vehicle sensor data source 12, OEM vehicle sensor data source 14, application data source 16, telematics data source 20, wireless infrastructure data source 17, and third party data source 15 or the like. In at least one embodiment, the determined events can correspond to location data, vehicle sensor data, various user interactions, display operations, impressions, or the like, that can be managed by downstream components of the system, such as

Stream Processing Server system 200 and Analytics Server system 500. In at least one embodiment, Ingress Server system 100 can ingress more or fewer event sources than shown in FIG. 1.

In at least one embodiment, events that can be received and/or determined from one or more event sources includes vehicle event data from one or more data sources, for example GPS devices, or location data tables provided by third party data source 15, such as OEM vehicle sensor data source 14. Vehicle event data can be ingested in database formats, for example, JSON, CSV, and XML. The vehicle event data can be ingested via APIs or other communication interfaces provided by the services and/or the Ingress Server system 100. For example, Ingress Server system 100 can offer an API Gateway 102 interface that integrates with an Ingress Server API 106 that enables Ingress Server system 100 to determine various events that can be associated with databases provided by the vehicle event source 14. An exemplary API gateway can include, for example AWS API Gateway. An exemplary hosting platform for an Ingress Server system 100 system can include Kubernetes and Docker, although other platforms and network computer configurations can be employed as well.

In at least one embodiment, the Ingress Server system 100 includes a Server 104 configured to accept raw data, for example, a Secure File Transfer Protocol Server (SFTP), an API, or other data inputs can be configured accept vehicle event data. The Ingress Server system 100 can be configured to store the raw data in data store 107 for further analysis, for example, by an Analytics Server system 500. Event data can include Ignition on, time stamp (T1 . . . TN), Ignition off, interesting event data, latitude and longitude, and Vehicle Information Number (VIN) information. Exemplary event data can include Vehicle Movement data from sources as known in the art, for example either from vehicles themselves (e.g. via GPS, API) or tables of location data provided from third party data sources 15.

In at least one embodiment, the Ingress Server system 100 is configured to clean and validate data. For example, the Ingress Server 100 can be configured include Ingress API 106 that can validate the ingested telematics and location data and pass the validated location data to a server queue 108, for example, an Apache Kafka queue, which is then outputted to the Stream Processing Server 300. The server 108 can be configured to output the validated ingressed location data to the data store 107 as well. The Ingress Server can also be configured pass invalid data to a data store 107. For example, invalid payloads can be stored in data store 107. Exemplary invalid data can include, for example, data with bad fields or unrecognized fields, or identical events.

In an embodiment, the system is configured to detect and map vehicle locations with enhanced accuracy. In order to gather useful aggregates about the road network, for example expected traffic volumes and speeds across the daily/weekly cycle, the system can be configured to determine how vehicles are moving through a given road network. As noted herein, a naïve approach of associating or “snapping” each data point with a nearest section of a road can fail because vehicle GPS data has an inherent degree of error due to various known physical effects. Further, a road network often approaches and crosses itself in complicated geometries leading to locations with multiple snapping candidates.

In an embodiment, the system can be configured to include a base map given as a collection of line segments for road segments. The system includes, for each line segment, geometrical information regarding the line segment's relation to its nearest neighbors. For each line segment, statistical information regarding expected traffic volumes and speeds is generated from an initial iteration of the process. As shown above, vehicle movement event data comprises longitude, latitude, heading, speed and time-of-day.

In an embodiment, the system is configured to take a collection of line segments, which corresponds to road segments, and create an R-Tree index over the collection of line segments. R-trees are tree data structures used for spatial access methods, i.e., for indexing multi-dimensional information such as geographical coordinates, rectangles or polygons. The R-tree is configured TO store spatial objects as bounding box polygons to represent, inter alia, road segments. The R-Tree is first used to find road segment candidates within a prescribed distance of a coordinate in order to snap a data point. The candidates are then further examined using a refined metric that considers event data such as the heading select a road segment, which is most likely based on all known information. Event data such as speed and/or time-of-day can also be employed to select a road segment.

The Ingress Server 100 can be configured to output the stored invalid data or allow stored data to be pulled to the Analysis Server 500 from the data store 107 for analysis, for example, to improve system performance. For example, the Analysis Server 500 can be configured with diagnostic machine learning configured to perform analysis on databases of invalid data with unrecognized fields to newly identify and label fields for validated processing. The Ingress Server 100 can also be configured to pass stored ingressed location data for processing by the Analytics server 500, for example, for Journey analysis as described herein.

In an embodiment, the Ingress Server 100 is configured to process event data to derive vehicle movement data, for example speed, duration, and acceleration. For example, in an embodiment, a snapshot is taken on the event database every x number of seconds (e.g. 3 seconds). Lat/long data and time data can then be processed to derive vehicle tracking data, such as speed and acceleration, using vehicle position and time.

In an embodiment, the Ingress Server 100 is configured to accept data from devices and third party platforms. The Ingress API 106 can be configured to authenticate devices and partner or third party platforms and platform hosts to the system 10.

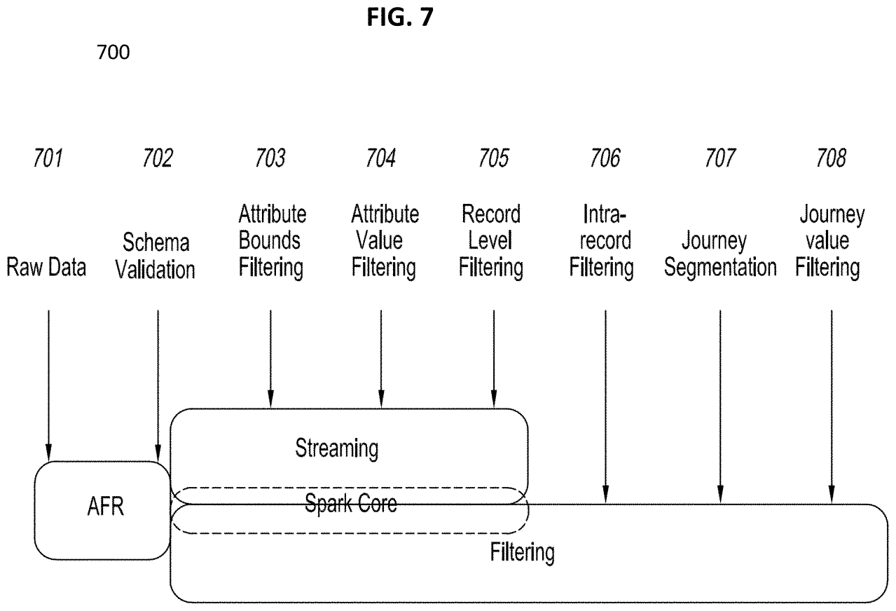

Accordingly, in an embodiment, the Ingress Server 100 is configured to received raw data and perform data quality checks for raw data and schema evaluation. Ingesting and validating raw data is the start of a data quality pipeline of quality checks for the system as shown in FIG. 7 at block 701. Table 1 shows an example of raw data received into the system.

TABLE 1

| | Attribute | Type | Nullable | Description |
|---|---|---|---|---|
| Raw | partner_id | Integer | No | Identifier for ingress partner |
| Data | device_id | String | Yes | 4-9 characters long |
| | captured_timestamp | String | No | Time of an event, expressed in local |
| | | | | time with UTC offset |
| | received_timestamp | String | No | Time event was received by Ingress |
| | | | | Server, UTC |
| | longitude, latitude | Double | No | WGS84 coordinates of an event |
| | speed | Float | No | Vehicle speed in kilometers per hour |
| | | | | recorded at the time of an event |
| | additional | Map | No | Map of string key-value pairs to |
| | | | | express data attributes unique to each |
| | | | | ingress |
| | journey_id | String | No | An identifier for a journey and the |
| | | | | associated events within it |
| | heading | Integer | Yes | Clockwise orientation of vehicle, 0 |
| | | | | equals North |
| | altitude | Integer | Yes | Elevation of vehicle as reported by |
| | | | | GPS |
| | squish_vin | String | Yes | Encoded representation of vehicle |
| | | | | make/model characteristics |
| | ignition_status | String | Yes | Indicator of whether vehicle is under |
| | | | | power |

In another embodiment, vehicle event data from an ingress source can include less information. For example, as shown in Table 2, the raw vehicle event data can comprise a limited number of attributes, for example, location data (longitude and latitude) and time data (timestamps).

TABLE 2

| | Attribute | Type | Nullable | Description |
|---|---|---|---|---|
| Raw | captured_timestamp | String | No | Time of an event, |
| Data. | | | | expressed in local |
| | | | | time with UTC offset |
| | received_timestamp | String | No | Time event was |
| | | | | received by Ingress |
| | | | | Server, UTC |
| | longitude, latitude | Double | No | WGS84 coordinates |
| | | | | of an event |

An exemplary advantage of embodiments of the present disclosure is that information that is absent can be derived from innovative algorithms as described herein. For example, vehicle event data may not include a journey identification, or may have a journey identification that is inaccurate. Accordingly, the system can be configured to derive additional vehicle event attribute data when the initially ingressed data has limited attributes. For example, the system can be configured to identify a specific vehicle for ingressed vehicle event data and append a Vehicle ID. The system can thereby trace vehicle movement—including starts and stops, speed, heading, acceleration, and other attributes using, for example, only location and timestamp data associated with a Vehicle ID.

In an embodiment, at block 702, data received can conform to externally defined schema, for example, Avro or JSON. The data can be transformed into internal schema and validated. In an embodiment, event data can be validated against an agreed schema definition before being passed on to the messaging system for downstream processing by the data quality pipeline. For example, an Apache Avro schema definition can be employed before passing the validated data on to an Apache Kafka messaging system. In another embodiment, the raw movement and event data can also be processed by a client node cluster configuration, where each client is a consumer or producer, and clusters within an instance can replicate data amongst themselves.

For example, the Ingress server system 100 can be configured with a Pulsar Client connected to an Apache Pulsar end point for a Pulsar cluster. In an embodiment, the Apache Pulsar end point keeps track of the last data read, allowing an Apache Pulsar Client to connect at any time to pick up from the last data read. In Pulsar, a “standard” consumer interface involves using “consumer” clients to listen on topics, process incoming messages, and finally acknowledge those messages when the messages have been processed. Whenever a client connects to a topic, the client automatically begins reading from the earliest unacknowledged message onward because the topic's cursor is automatically managed by a Pulsar Broker module. However, a client reader interface for the client enables the client application to manage topic cursors in a bespoke manner. For example, a Pulsar client reader can be configured to connect to a topic to specify which message the reader begins reading from when it connects to a topic. When connecting to a topic, the reader interface enables the client to begin with the earliest available message in the topic or the latest available message in the topic. The client reader can also be configured to begin at some other message between the earliest message and the latest message, for example by using a message ID to fetch messages from a persistent data store or cache.

In at least one embodiment, the Ingress Server system 100 is configured to clean and validate data. For example, the Ingress Server system 100 can be configured include an Ingress Server API 106 that can validate the ingested vehicle event and location data and pass the validated location data to a server queue 108, for example, an Apache Kafka queue 108, which is then outputted to the Stream Processing Server system 200. Server 104 can be configured to output the validated ingressed location data to the data store 107 as well. The Ingress Server system 100 can also be configured to pass invalid data to a data store 107. The map database can be, for example, a point of interest database or other map database, including public or proprietary map databases. Exemplary map databases can include extant street map data such as Geofabric for local street maps, or World Map Database. The system can be further configured to egress the data to external mapping interfaces, navigation interfaces, traffic interfaces, and connected car interfaces as described herein.

In an embodiment, at block 702, data received can conform to externally defined schema, for example, Avro or JSON. The Ingress Server system 100 can be configured to output the stored invalid data or allow stored data to be pulled to the Analysis Server system 500 from the data store 107 for analysis, for example, to improve system performance. For example, the Analysis Server system 500 can be configured with diagnostic machine learning configured to perform analysis on databases of invalid data with unrecognized fields to newly identify and label fields for validated processing. The Ingress Server system 100 can also be configured to pass stored ingressed location data for processing by the Analytics Server system 500, for example, for Journey analysis as described herein.

As described herein, the system 10 is configured to process data in both a streaming and a batch context. In the streaming context, low latency is more important than completeness, i.e. old data need not be processed, and in fact, processing old data can have a detrimental effect as it may hold up the processing of other, more recent data. In the batch context, completeness of data is more important than low latency. Accordingly, to facilitate the processing of data in these two contexts, in an embodiment, the system can default to a streaming connection that ingresses all data as soon as it is available but can also be configured to skip old data. A batch processor can be configured to fill in any gaps left by the streaming processor due to old data.

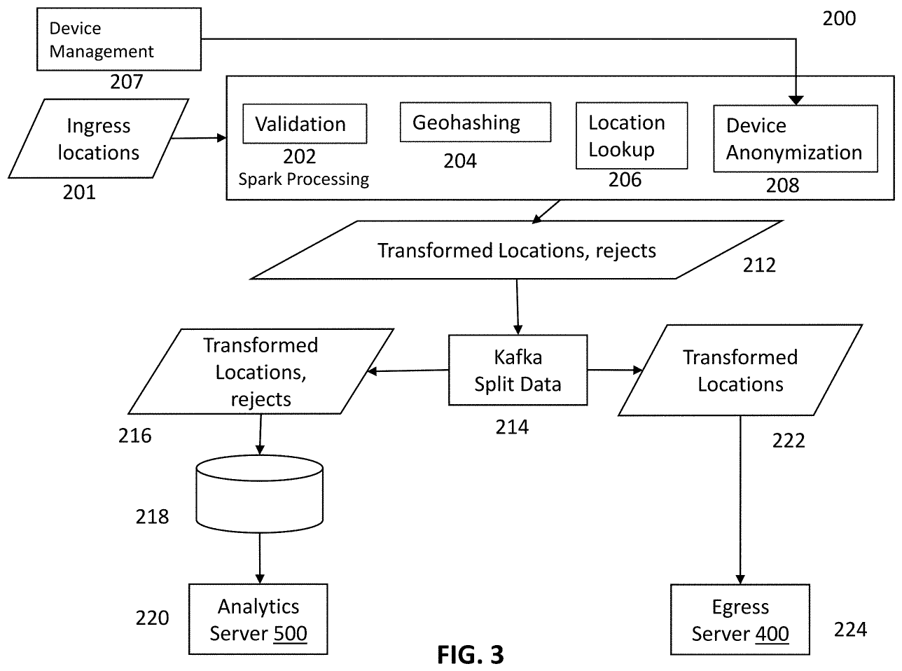

FIG. 3 is a logical architecture for a Stream Processing Server system 200 for data throughput and analysis in accordance with at least one embodiment. Stream processing as described herein results in system processing improvements, including improvements in throughput in linear scaling of at least 200 k to 600 k records per second. Improvement further includes end-to-end system processing of 20 seconds, with further improvements to system latency being ongoing. In at least one embodiment, the system can be configured to employ a server for micro-batch processing. For example, as described herein, in at least one embodiment, the Stream Processing Server system 200 can be configured to run on a web services platform host such as AWS employing a Spark Streaming server and a high throughput messaging server such as Apache Kafka. In an embodiment, the Stream Processing Server system 200 can include Device Management Server 207, for example, AWS Ignite, which can be configured input processed data from the data processing server. The Device Management Server 207 can be configured to use anonymized data for individual vehicle data analysis, which can be offered or interfaced externally. The system 10 can be configured to output data in real time, as well as to store data in one or more data stores for future analysis. For example, the Stream Processing Server system 200 can be configured to output real time data via an interface, for example Apache Kafka, to the Egress Server system 400. The Stream Processing Server system 200 can also be configured to store both real-time and batch data in the data store 107. The data in the data store 107 can be accessed or provided to the Insight Server system 500 for further analysis.

In at least one embodiment, event information can be stored in one or more data stores 107, for later processing and/or analysis. Likewise, in at least one embodiment, event data and information can be processed as it is determined or received. Also, event payload and process information can be stored in data stores, such as data store 107, for use as historical information and/or comparison information and for further processing.

In at least one embodiment, the Stream Processing Server system 200 is configured to perform vehicle event data processing.

FIG. 3 illustrates a logical architecture and overview flowchart for a Steam Processing Server system 200 in accordance with at least one embodiment. At block 202, the Stream Processing Server system 200 performs validation of location event data from ingressed locations 201. Data that is not properly formatted, is duplicated, or is not recognized is filtered out. Exemplary invalid data can include, for example, data with bad fields, unrecognized fields, or identical events (duplicates) or engine on/engine off data points occurring at the same place and time. The validation also includes a latency check, which discards event data that is older than a predetermined time period, for example, 7 seconds. In an embodiment, other latency filters can be employed, for example between 4 and 15 seconds.

In an embodiment, as shown at block 703 of FIG. 7, the Stream Processing Server system 200 is configured perform Attribute Bounds Filtering. Attribute Bounds Filtering checks to ensure event data attributes are within predefined bounds for the data that is meaningful for the data. For example, a heading attribute is defined as a circle (0→359). A squish-vin is a 9-10 character VIN. Examples include data that is predefined by a data provider or set by a standard. Data values not within these bounds indicate the data is inherently faulty for the Attribute. Non-conforming data can be checked and filtered out. An example of Attribute Bounds Filtering is given in Table 3.

TABLE 3

| | | | | | | | Data |
|---|---|---|---|---|---|---|---|
| Attribute | | | | | | Data | Points |
| Bounds | | | | | | Points | Flagged |
| Filtering | | Attribute | Units | Defined by | Bounds | Flagged | (%) |
| Values | Attributes | device_id | String | Externally | N/A | 27 | 0.00171% |
| within | contain | longitude, | Double | Internally | to spec | 586 | 586 |
| meaningful | only values | latitude | | | | | |
| range. | within | heading | Integer | Externally | 0 → 359 | 94 | 0.00004% |
| | externally | squish_vin | String | Externally | 9-10 characters | 0 | 0% |
| | predefined | | | | | | |
| | boundaries. | | | | | | |

In an embodiment, at block 704 the system is configured to perform Attribute Value Filtering. Attribute Value Filtering checks to ensure attribute values are internally set or bespoke defined ranges. For example, while a date of 1970 can pass an Attribute Bounds Filter check for a date Attribute of the event, the date is not a sensible value for vehicle tracking data. Accordingly, Attribute Value Filtering is configured to filter data older than a predefined time, for example 6 weeks or older, which can be checked and filtered. An example Attribute Bounds Filtering is given in Table 3.

TABLE 3

| | | | | | | | Data |
|---|---|---|---|---|---|---|---|
| Attribute | | | | | | Data | Points |
| Value | | | | Defined | Defined | Points | Flagged |
| Filtering | | Attribute | Units | by | Bounds | Flagged | (%) |
| Values | Attributes | captured_timestamp | Timestamp | | <6 weeks | | 64296 |
| within | contain | | | | ago | | |
| reasonable | only values | received_timestamp | Timestamp | | > now | | 0 |
| range. | within | longitude, latitude | degrees | Internally | bounding | | 0 |
| | internally | | | | box | | |
| | defined | Speed | kph | Internally | 0 → 360 | | 0 |
| | boundaries. | Altitude | metres | Internally | −1000 → 10000 | | |

At block 705, the system can perform further validation on Attributes in a record to confirm that relationships between attributes of record data points are coherent. For example, a non-zero trip start event does not make logical sense for a Journey determination as described herein. Accordingly, as shown in Table 4, the system 10 can be configured to filter non-zero speed events recorded for the same Attributes for a captured timestamp and a received timestamp for a location as “TripStart” or Journey ignition on start event.

TABLE 4

| Record-Level | | | Data Points | Data Points |
|---|---|---|---|---|
| Filtering | Attributes | Conditions | Flagged | Flagged (%) |
| Row contents | speed, | speed > 0 AND | 439 | 0.0004% |
| have semantic | ignition_status | ignition_status IN | | |
| meaning. | | (‘KEY_OFF’, | | |
| | | ‘KEY_ON’) | | |
| | captured_timestamp, | received_timestamp < | 41 | 0.00004% |
| | received_timestamp | captured_timestamp | | |

Returning to FIG. 2, at block 204, in at least one embodiment, the Stream Processing Server 200 performs geohashing of the location event data. While alternatives to geohashing are available, such as an H3 algorithm as employed by Uber™, or a S2 algorithm as employed by Google™, it was found that geohashing provided exemplary improvements to the system 10, for example improvements to system latency and throughput. Geohashing also provided for database improvements in system 10 accuracy and vehicle detection. For example, employing a geohash to 9 characters of precision can allow a vehicle to be uniquely associated the geohash. Such precision can be employed in Journey determination algorithms as described herein. In at least one embodiment, the location data in the event data is encoded to a proximity, the encoding comprising geohashing latitude and longitude for each event to a proximity for each event. The event data comprises time, position (lat/long), and event of interest data. Event of interest data can include harsh brake and harsh acceleration. For example, a harsh brake can be defined as a deceleration in a predetermined period of time (e.g. 40-0 in x seconds), and a harsh acceleration is defined as an acceleration in a predetermined period of time (e.g. 40-80 mph in x seconds). Event of interest data can be correlated and processed for employment in other algorithms. For example, a cluster of harsh brakes mapped in location to a spatiotemporal cluster can be employed as a congestion detection algorithm.

The geohashing algorithm encodes latitude and longitude (lat/long) data from event data to a short string of n characters. In an embodiment, the geohashed lat/long data is geohashed to a shape. For example, in an embodiment, the lat/long data can be geohashed to a rectangle whose edges are proportional to the characters in the string. In an embodiment, the geohash can be encoded from to 4 to 9 characters.

A number of advantages flow from employing geohashed event data as described herein. For example, in a database, data indexed by geohash will have all points for a given rectangular area in contiguous slices, where the number of slices is determined by the geohash precision of encoding. This improves the database by allowing queries on a single index, which is much easier or faster than multiple-index queries. The geohash index structure is also useful for streamlined proximity searching, as the closest points are often among the closest geohashes.

At block 206, in at least one embodiment, the Stream Processing Server system 200 performs a location lookup. As noted above, in an embodiment, the system can be configured to encode the geohash to identify a defined geographical area, for example, a country, a state, or a zip code. The system can geohash the lat/long to a rectangle whose edges are proportional to the characters in the string.

For example, in an embodiment, the geohashing can be configured to encode the geohash to 5 characters, and the system can be configured to identify a state to the 5-character geohashed location. For example, the geohash encoded to 5 slices or characters of precision is accurate to +/−2.5 kilometers, which is sufficient to identify a state. A geohash to 6 characters can be used to identify the geohashed location to a zip code, as it is accurate to +/−0.61 kilometers. A geohash to 4 characters can be used to identify a country. In an embodiment, the system 10 can be configured to encode the geohash to uniquely identify a vehicle with the geohashed location. In an embodiment, the system 10 can be configured to encode the geohash to 9 characters to uniquely identify a vehicle.

In an embodiment, the system 10 can be further configured to map the geohashed event data to a map database. The map database can be, for example, a point of interest database or other map database, including public or proprietary map databases. Exemplary map databases can include extant street map data such as Geofabric for local street maps, or World Map Database. The system can be further configured to produce mapping interfaces. An exemplary advantage of employing geohashing as described herein is that it allows for much faster, low latency enrichment of the vehicle event data when processed downstream. For example, geographical definitions, map data, and other enrichments are easily mapped to geohashed locations and Vehicle IDs. Feed data can also be combined into an aggregated data set and visualized using an interface, for example a GIS visualization tool (e.g.: Mapbox, CARTO, ArcGIS, or Google Maps API) or other interfaces to produce and interface graphic reports or to output reports to third parties 15 using the data processed to produce the analytics insights, for example, via the Egress Server system 400 or Portal Server system 600.

In at least one embodiment, at block 208, the Stream Processor Server system 200 can be configured to anonymize the data to remove identifying information, for example, by removing or obscuring personally identifying information from a Vehicle Identification Number (VIN) for vehicle data in the event data. In various embodiments, event data or other data can include VIN numbers, which include numbers representing product information for the vehicle, such as make, model, and year, and also includes characters that uniquely identify the vehicle, and can be used to personally identify it to an owner. The system 10 can include, for example, an algorithm that removes the characters in the VIN that uniquely identify a vehicle from vehicle data but leaves other identifying serial numbers (e.g. for make, model and year), for example, a Squish Vin algorithm. In an embodiment, the system 10 can be configured to add a unique vehicle tag to the anonymized data. For example, the system 10 can be configured to add unique numbers, characters, or other identifying information to anonymized data so the event data for a unique vehicle can be tracked, processed and analyzed after the personally identifying information associated with the VIN has been removed. An exemplary advantage of anonymized data is that the anonymized data allows processed event data to be provided externally while still protecting personally identifying information from the data, for example as may be legally required or as may be desired by users.

In at least one embodiment, as described herein, a geohash to 9 characters can also provide unique identification of a vehicle without obtaining or needing personally identifying information such as VIN data. Vehicles can be identified via processing a database event data and geohashed to a sufficient precision to identify unique vehicles, for example to 9 characters, and the vehicle can then be identified, tracked, and their data processed as described herein.

In an embodiment, data can be processed as described herein. For example, un-aggregated data can be stored in a database (e.g. Parquet) and partitioned by time. Data can be validated in-stream and then reverse geocoded in-stream. Data enrichment, for example by vehicle type, can be performed in-stream. The vehicle event data can aggregated, for example, by region, by journey, and by date. The data can be stored in Parquet, and can also be stored in Postgres. Reference data can be applied in Parquet for in-stream merges. Other reference data can be applied in Postgres for spatial attributes.

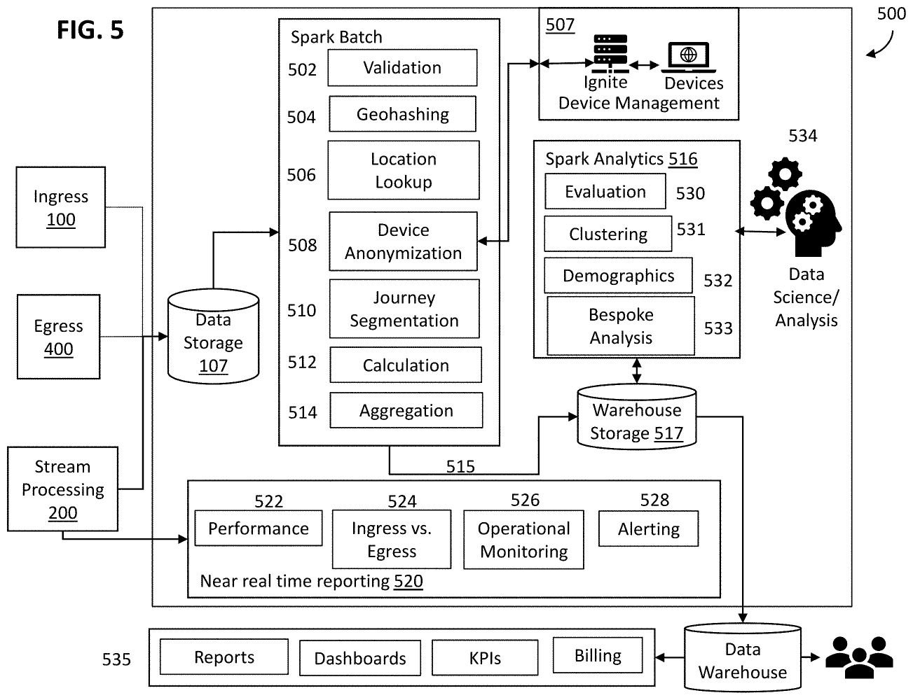

As noted above, for real-time streaming, at block 202, the data validation filters out data that has excess latency, for example a latency over 7 seconds. However, batch data processing can run with a full set of data without gaps, and thus can include data that is not filtered for latency. For example, a batch data process for analytics as described with respect to FIG. 5 can be configured to accept data up to 6 weeks old, whereas the streaming stack of Stream Processing Server system 200 is configured to filter data that is over 7 seconds old, and thus includes the latency validation check at block 202 and rejects events with higher latency.

In an embodiment, at block 212, both the transformed location data filtered for latency and the rejected latency data are input to a server queue, for example, an Apache Kafka queue. At block 214, the Stream Processing server system 200 can split the data into a data set including full data 216—the transformed location data filtered for latency and the rejected latency data—and another data set of the transformed location data 222. The full data 216 is stored in data store 107 for access or delivery to the Analytics Server system 500, while the filtered transformed location data is delivered to the Egress Server system 400. In another embodiment, the full data set or portions thereof including the rejected data can also be delivered to the Egress Server system 400 for third party platforms for their own use and analysis. In such an embodiment, at block 213 transformed location data filtered for latency and the rejected latency data can be provided directly to the Egress Server system 400.

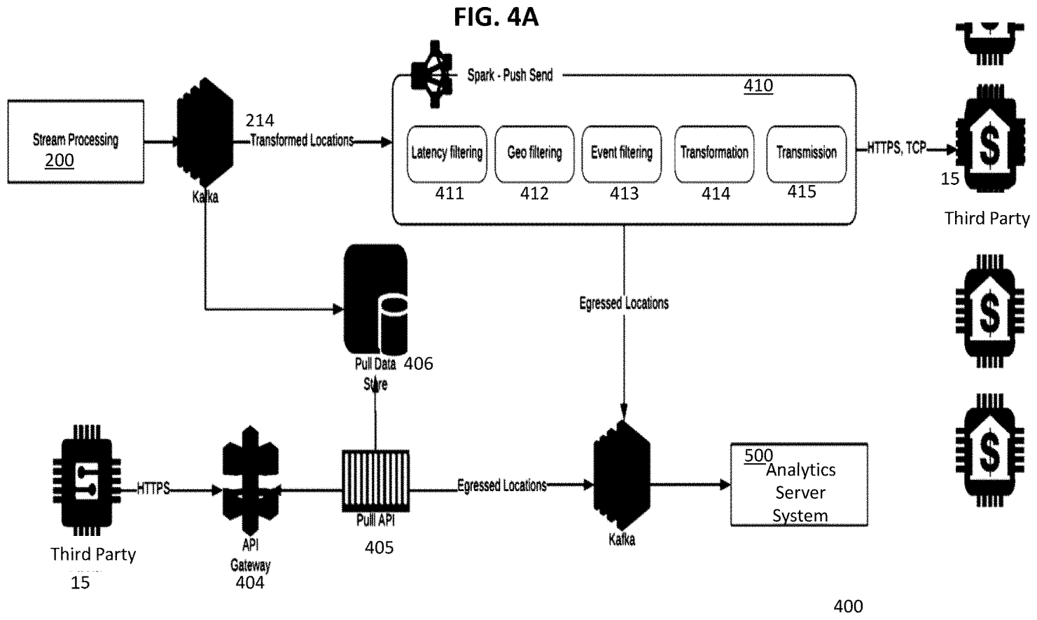

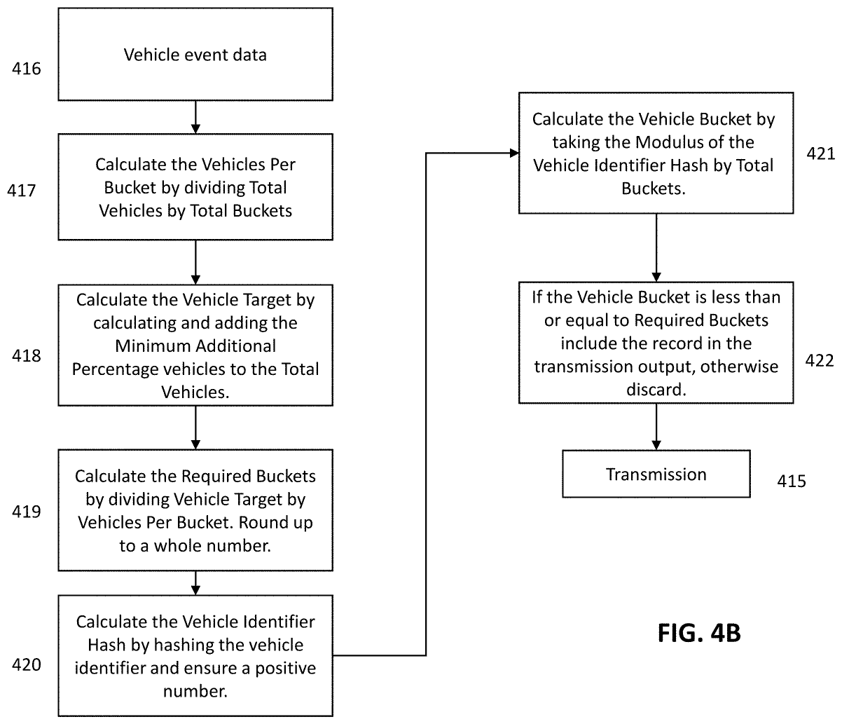

FIG. 4A is a logical architecture for an Egress Server system 400. In at least one embodiment, Egress Server system 400 can be one or more computers arranged to ingest throughput records and output event data. For example, in an embodiment, the system 10 can be configured to employ a push server 410 from an Apache Spark Cluster. The push server 410 can be configured to process transformed location data from the Stream Process Server system 200, for example, for latency filtering 411, geo filtering 412, event filtering 413, transformation 414 and transmission 415. As described herein, geohashing improves system 10 throughput latency, which allows for advantages in timely push notification for data processed in close proximity to events, for example within minutes and even seconds. For example, in an embodiment, the system 10 is configured to target under 60 seconds of latency. As noted above, Stream Processing Server system 200 is configured to filter events with a latency of less than 7 seconds, also improving throughput. In an embodiment, a data store 406 for pull data can be provided via an API gateway 404, and a Pull API 405 can track which third party 15 users are pulling data and what data users are asking for.

In at least one embodiment, Egress Server 400 can comprise one or more computers arranged to ingest throughput records and output event data. The Egress Server 400 system can be configured to provide data on a push or pull basis. For example, in an embodiment, the system can be configured to employ a server Push server 410 from an Apache Spark Cluster or a distributed server system for parallel processing via multiple nodes, for example a Scala or Java platform on an Akka Server Platform.

In an embodiment, as described herein, geohashing improves system throughput latency considerably, which allows for advantages in timely push notification for data processed in close proximity to events, for example within minutes and even seconds. For example, in an embodiment, the system is configured to target under 60 seconds of latency. As noted above, stream processing is configured to filter events with a latency of less than 7 seconds, thereby also improving throughput. In another embodiment, the Egress Server can include event analysis algorithms for providing high throughput, and low latency streams for downstream interfaces, for example partner client interfaces 20.

In an embodiment, a data store 403 for pull data can be provided, and a Pull API 404 can track which users are pulling data and what data they are asking for.

For example, in an embodiment, the Egress Server 400 can provide pattern data based on filters provided by the system. For example, the system can be configured to provide a geofence filter to filter event data for a given location or locations. As will be appreciated, geofencing can be configured to bound and process journey and/or event data as described herein for numerous patterns and configurations. For example, in an embodiment, the Egress Server can be configured to provide a “Parking” filter configured to restrict the data to the start and end of journey (Ignition—key on/off events) within the longitude/latitudes provided or selected by a user. Further filters or exceptions for this data can be configured, for example by state (state code or lat/long). The system can also be configured with a “Traffic” filter to provide traffic pattern data, for example, with given states and lat/long bounding boxes excluded from the filters.

In an embodiment, the Egress Server 400 can be configured to process data with low-latency algorithms configured to maintain and improve low latency real-time throughput. The algorithms can be configured to process the data for low-latency file output that can populate downstream interfaces requiring targeted, real-time data that does not clog computational resources or render them inoperable. In an embodiment, the system is configured to provide low latency average road speed data for road segments for output in virtually real time from a live vehicle movement data stream from the Stream Processing Server 200. The Egress Server 400 can also be configured to delete raw data in order to provide lightweight data packages to partners 20 and to be configured for downstream interfaces, for example via the Push Server 410.

In an embodiment, the Egress Server can be configured to throttle data being transmitted externally without applying filters. One exemplary advantage of configuring the system to throttle egressed data is the ability to control the number of vehicle event data analyses and to control the size of data packages egressed to external systems and clients. As will be appreciated, external systems and clients may not be configured to accept the volume of vehicle event data processed by the system. Yet another exemplary advantage of employing filterless throttling is that the system can employ a relatively lightweight algorithm to process high volumes of vehicle event data and the analysis thereof without complex filters, which negatively impact latency and processing.

FIG. 4B shows a process for throttling vehicle event data. At block 416, the system is configured to ingest high throughput real time vehicle movement event data, which includes standard trip event data ingressed by the Ingress Server 100 and processed by the Stream Processing Server 300, which includes information such as a device ID, lat/long, ignition status, speed, and a time stamp.

In an embodiment, the system is configured to throttle data based on a vehicle identifier for a vehicle. The system can be configured to throttle data for driving event data and vehicle movement data. The system can also be configured to employ throttling for both Stream Processing by the Stream Processing Server 200 or batch Processing, for example by the Analytics Server 500. The system can be configured to employ a unique vehicle ID that is random and not geographically biased.

The system is configured to provide vehicle event data from a vehicle movement event data stream. The vehicle event data is processed using the information shown in Table 5.

TABLE 5

| | Term | Details |
|---|---|---|
| 1 | Vehicle | The random unique identifier for a vehicle. |
| | Identifier | |
| 2 | Total | The total number of vehicles on the platform in the |
| | Vehicles | previous month as captured in the datamart |
| | | aggregations. These are held per OEM/third party |
| | | environment. |
| 3 | Total | The total number of pots (buckets) to split the |
| | Buckets | vehicles into. This is a configurable value per OEM |
| | | environment. It should not exceed the Total Vehicles. |
| 4 | Vehicle | The approximate number of vehicles to restrict an |
| | Limit | Egress partner to. This is a configurable value per |
| | | Egress partner feed. |
| 5 | Minimum | The minimum percentage of additional vehicles that |
| | Additional | will be added to the output. This is a configurable |
| | Percentage | value per OEM environment. It accounts for not all |
| | | vehicles being active in a given period as well as |
| | | compensate for the fact the bucketing is not exact. |
| 6 | Vehicles | The number of vehicles that will be in each bucket |
| | Per | (assuming uniform distribution). Calculated. |
| | Bucket | |
| 7 | Required | The number of buckets that are needed to provide |
| | Buckets | the required number of vehicles. Calculated. |
| 8 | Vehicle | The target number of vehicles to send to the Egress |
| | Target | partner. Calculated. |
| 9 | Vehicle | The positive hash for the vehicle identifier. |
| | Identifier | Calculated. |
| | Hash | |
| 10 | Vehicle | The bucket that a vehicle is assigned to. |
| | Bucket | |

At block 417, the system is configured to calculate the Vehicles Per Bucket by dividing Total Vehicles by Total Buckets. At block 418, the system is configured to calculate a Vehicle Target by calculating and adding a Minimum Additional Percentage of vehicles to the Total Vehicles. At block 419, the system is configured calculate a Required Buckets by dividing Vehicle Target by Vehicles Per Bucket. The Required Buckets are rounded up to a whole number. In an embodiment, blocks 417 to 419 are periodically recalculated to adjust for fluctuating volumes of vehicles from the vehicle event data. For example, recalculating every 24 hours proved advantageous for identifying traffic patterns. In an embodiment, blocks 417 to 419 can also be precalculated, and the system does not require that the calculations be run for every vehicle record.

At block 420, the system is configured to calculate a Vehicle Identifier Hash by hashing the vehicle identifier and ensuring a positive number. At block 421, the system is configured to calculate a Vehicle Bucket by taking the Modulus of the Vehicle Identifier Hash by the Total Buckets. At block 422, if the Vehicle Bucket is less than or equal to the Required Buckets, the record is included in the Bucket and transmitted for Egress output at block 415 (FIG. 4A). If the Vehicle Bucket is greater than the Required Buckets, the record is discarded from the Egress output. As will be appreciated, the original record and processed journey and trip data can be preserved and stored. In an embodiment, data is only outputted or deleted, depending on whether is meets the Required Bucket criteria. Accordingly, another advantage of the throttling algorithm is that it improves system performance and data output performance by selectively deleting or outputting data without the need for filters.

A worked example for a throttling algorithm described with respect to FIG. 4B is as follows:
Total Vehicles=9.2 million
Total Buckets=1 million
Vehicle Limit=3 million
Minimum Additional Percentage=5%
Vehicle ID=Vehicle12345
Vehicles Per Bucket=Total Vehicles/Total Buckets=9.2 million/1 million=9.2
Vehicle Target=(Vehicle Limit*Minimum Additional Percentage)+Vehicle Limit=(3 million*5%)+3 million=3.15 million
Required Buckets=Round Up (Vehicle Target/Vehicles Per Bucket)=Round Up (3.15 million/9.2)=342392
Vehicle Identifier Hash=Hash (Vehicle Identifier)=Hash (Vehicle12345)=1909956441
Vehicle Bucket=Vehicle Identifier Hash % Total Buckets=1909956441% 1 million=956441
Include in output=(Vehicle Bucket<=Required Buckets)=(956441<=342392)=false

As will be appreciated, the system can be configured to execute the hash using an appropriately powered partition algorithm, such as, for example, a Kafka partition hashing employing murmur2.

As explained herein, improved latency is not incidental to the design and implementation of the algorithm and event record containers employed to egress segment events, as low latency is an important technical feature of the system. Further, throttling event record containers allows downstream consoles, for example traffic management consoles, to operate. For example, at block 415 of FIG. 4A, segment event records can be transmitted in real time to external partners 20 from the push server 410. For example, in an embodiment, the segment event record can be configured to be delivered from the push server 410 to an interface such as an AWS S3 bucket, web sockets, or an API. In an embodiment, segment event records can be transmitted to the analytics server 500 for insight processing and output the portal server 600 for APIs or other interfaces. Thus, at block 418 the system is configured to discard the raw data at the Egress Server 400 to improve both the system's own latency and the operability downstream interfaces and consoles.

Another exemplary advantage of the system configuration is that the throttling algorithm is geographically agnostic. Because the algorithm is configured to use Vehicle ID, vehicle data and event data points can be egressed to third parties as a bucketed percentage of vehicles without limiting vehicles to a geographical filter. Thus, an external client can get a data flow that is representative across the total of the event data it wants without applying an unwanted filter, for example, by excluding specific geographical areas (e.g. states, regions, countries, targeted geofences).

Another exemplary advantage of the system configuration is it allows the system to control the amount of data provided to external entities without applying filters that alter the data. Thus, for example, if an external client is not configured for a larger volume of data, the system can be configured to throttle the data to a flow that the external client can operably process. The system can also be configured to determine how many vehicles are to be throttled per partner. Similarly, the system configuration can throttle the event data flow for other reasons, for example, to meet a client's or partner's contracted or system requirements for latency and availability. Accordingly, the throttling algorithm advantageously provides a consistent and predictable amount of data to support a client's need and system capability. Thus, for example, the system can be configured to ensure the number of vehicles sent to an egress partner remains substantially the same as vehicles come and go from the platform.

Another exemplary advantage is the system can be configured to retain complete journey or trip data after the system throttles the data. In an embodiment, another exemplary advantage is the data can be throttled for both stream and batch delivery mechanisms.

FIGS. 5 represents logical architecture for an Analytics Server system 500 for data analytics and insight. In at least one embodiment, Analytics Server system 500 can be one or more computers arranged to analyze event data. Both real-time and batch data can be passed to the Analytics Server system 500 for processing from other components as described herein. In an embodiment, a cluster computing framework and batch processor, such as an Apache Spark cluster, which combines batch and streaming data processing, can be employed by the Analytics Server system 500. Data provided to the Analytics Server system 500 can include, for example, data from the Ingress Server system 100, the Stream Processing Server system 200, and the Egress Server system 400.

In an embodiment, the Analytics Server system 500 can be configured to accept vehicle event payload and processed information, which can be stored in data stores, such as data stores 107. As shown in FIG. 5, the storage includes real-time egressed data from the Egress Server system 400, transformed location data and reject data from the Stream Processing Server system 200, and batch and real-time, raw data from the Ingress Server system 100. As shown in FIG. 2, ingressed locations stored in the data store 107 can be output or pulled into the Analytics Server system 500. The Analytics Server system 500 can be configured to process the ingressed location data in the same way as the Stream Processor Server system 200 as shown in FIG. 2. As noted above, the Stream Processing Server system 200 can be configured to split the data into a full data set 216 including full data (transformed location data filtered for latency and the rejected latency data) and a data set of transformed location data 222. The full data set 216 is stored in data store 107 for access or delivery to the Analytics Server system 500, while the filtered transformed location data is delivered to the Egress Server system 400. As shown in FIG. 5, real time filtered data can be processed for reporting in near real time, including reports for performance 522, Ingress vs. Egress 524, operational monitoring 526, and alerts 528.

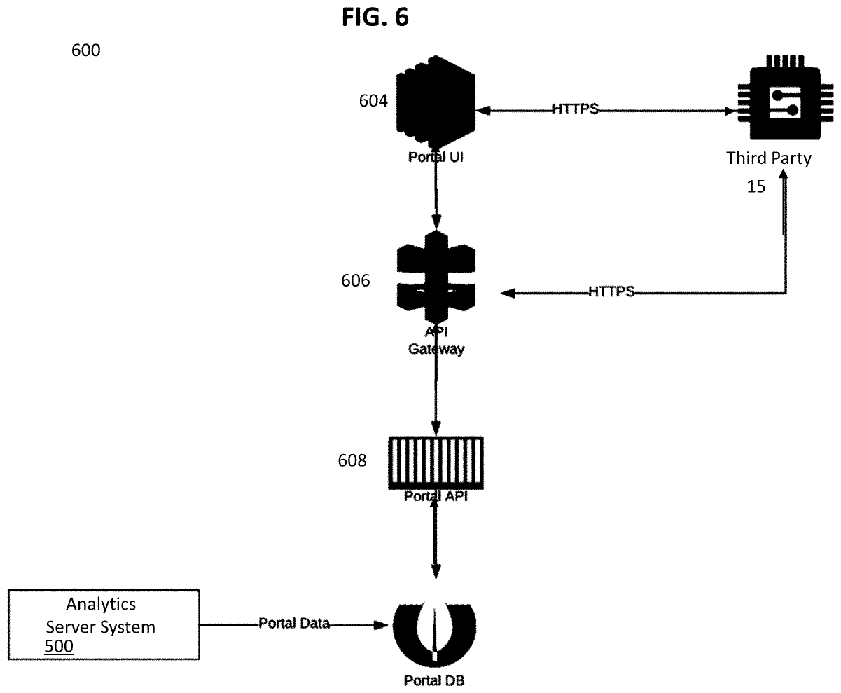

FIG. 6 is a logical architecture for a Portal Server system 600. In at least one embodiment, Portal Server system 600 can be one or more computers arranged to ingest and throughput records and event data. The Portal Server system 600 can be configured with a Portal User Interface 604 and API Gateway 606 for a Portal API 608 to interface and accept data from third party 15 users of the platform. In an embodiment, the Portal Server system 600 can be configured to provide daily static aggregates and is configured with search engine and access portals for real time access of data provided by the Analytics Server system 500. In at least one embodiment, Portal Server system 600 can be configured to provide a Dashboard to users, for example, to third party 15 client computers. In at least one embodiment, information from Analytics Server system 500 can flow to a report or interface generator provided by a Portal User interface 604. In at least one embodiment, a report or interface generator can be arranged to generate one or more reports based on the performance information. In at least one embodiment, reports can be determined and formatted based on one or more report templates.

The low latency provides a super-fast connection delivering information from vehicle source to end-user customer. Further data capture has a high capture rate of 3 seconds per data point, capturing up to, for example, 330 billion data points per month. As described herein, data is precise to lane-level with location data and 95% accurate to within a 3-meter radius, the size of a typical car.

FIG. 7 is a flow chart showing a data pipeline of data processing as described above. As shown in FIG. 7, in an embodiment, event data passes data through a seven (7) stage pipeline of data quality checks. In addition, data processes are carried out employing both stream processing and batch processing. Streaming operates on a record at a time and does not hold context of any previous records for a trip, and can be employed for checks carried out at the Attribute and record level. Batch processing can take a more complete view of the data and can encompass the full end-to-end process. Batch processing undertakes the same checks as streaming plus checks that are carried out across multiple records and Journeys.

In at least one embodiment, a dashboard display can render a display of the information produced by the other components of the system 10. In at least one embodiment, dashboard display can be presented on a client computer accessed over network. In at least one embodiment, user interfaces can be employed without departing from the spirit and/or scope of the claimed subject matter. Such user interfaces can have any number of user interface elements, which can be arranged in various ways. In some embodiments, user interfaces can be generated using web pages, mobile applications, GIS visualization tools, mapping interfaces, emails, file servers, PDF documents, text messages, or the like. In at least one embodiment, Ingress Server system 100, Stream Processing Server system 200, Egress Server system 400, Analytics Server system 500, or Portal Server system 600 can include processes and/or API's for generating user interfaces.

As described herein, embodiments of the system 10, processes and algorithms can be configured to run on a web services platform host such as Amazon Web Services (AWS)® or Microsoft Azure®. A cloud computing architecture is configured for convenient, on-demand network access to a shared pool of configurable computing resources (e.g. networks, network bandwidth, servers, processing, memory, storage, applications, virtual machines, and services). A cloud computer platform can be configured to allow a platform provider to unilaterally provision computing capabilities, such as server time and network storage, as needed automatically without requiring human interaction with the service's provider. Further, cloud computing is available over a network and accessed through standard mechanisms that promote use by heterogeneous thin or thick client platforms (e.g., mobile phones, laptops, and PDAs). In a cloud computing architecture, a platform's computing resources can be pooled to serve multiple consumers, partners or other third party users using a multi-tenant model, with different physical and virtual resources dynamically assigned and reassigned according to demand. A cloud computing architecture is also configured such that platform resources can be rapidly and elastically provisioned, in some cases automatically, to quickly scale out and rapidly released to quickly scale in.

Cloud computing systems can be configured with systems automatically control and optimize resource use by leveraging a metering capability at some level of abstraction appropriate to the type of service (e.g., storage, processing, bandwidth, and active user accounts). Resource usage can be monitored, controlled, and reported. As described herein, in embodiments, the system 10 is advantageously configured by the platform provider with innovative algorithms and database structures configured for low-latency.

A cloud computing architecture includes a number of service and platform configurations.

A Software as a Service (SaaS) is configured to allow a platform provider to use the provider's applications running on a cloud infrastructure. The applications are accessible from various client devices through a thin client interface such as a web browser (e.g., web-based e-mail). The consumer typically does not manage or control the underlying cloud infrastructure including network, servers, operating systems, storage, or even individual application capabilities, with the possible exception of limited user-specific application configuration settings.

A Platform as a Service (PaaS) is configured to allow a platform provider to deploy onto the cloud infrastructure consumer-created or acquired applications created using programming languages and tools supported by the provider. The consumer does not manage or control the underlying cloud infrastructure including networks, servers, operating systems, or storage, but can a have control over the deployed applications and possibly application hosting environment configurations.

An Infrastructure as a Service (IaaS) is configured to allow a platform provider to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

A cloud computing architecture can be provided as a private cloud computing architecture, a community cloud computing architecture, or a public cloud computing architecture. A cloud computing architecture can also be configured as a hybrid cloud computing architecture comprising two or more clouds platforms (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

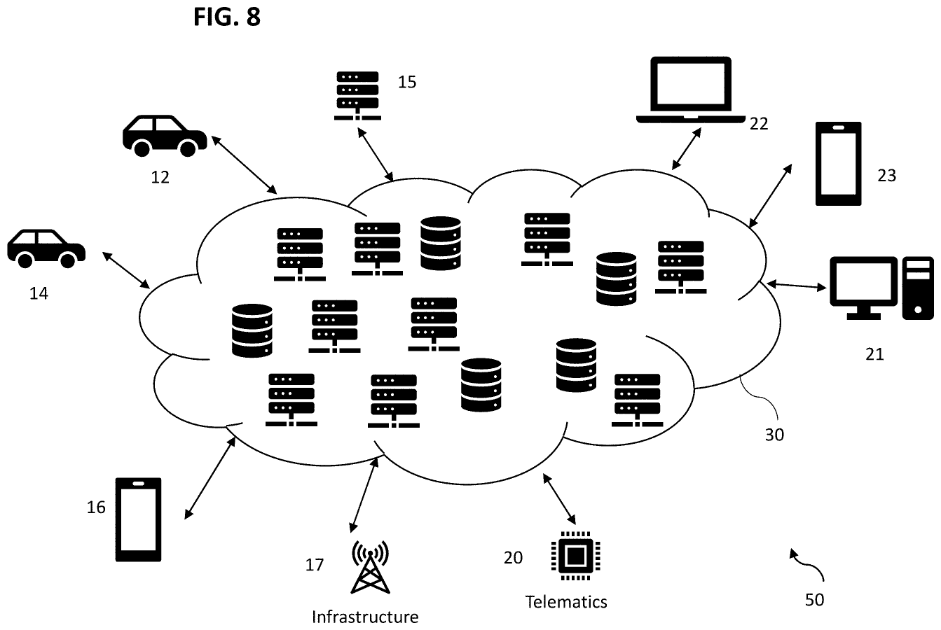

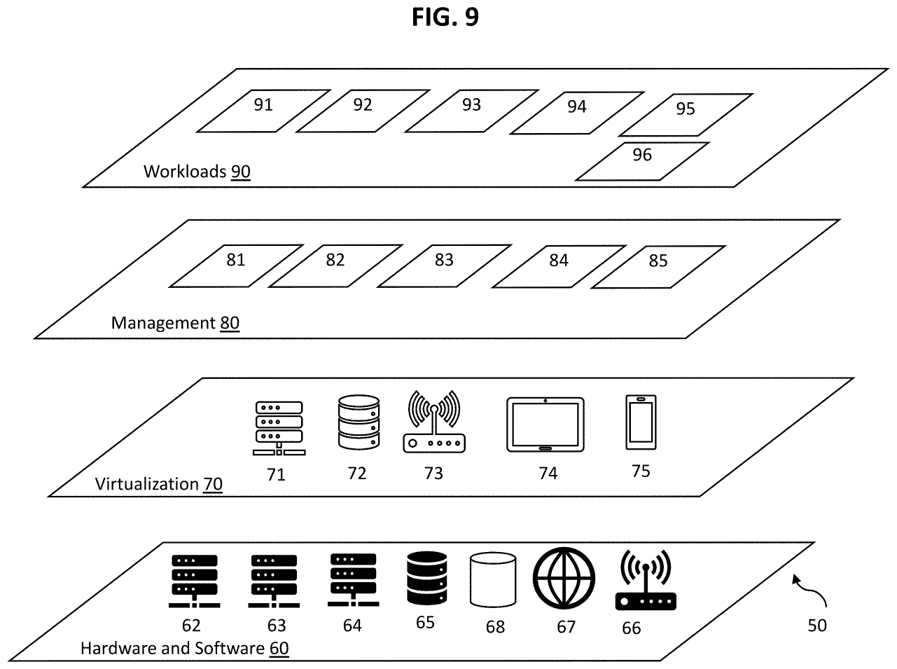

Referring now to FIG. 8, an illustrative cloud computing environment 50 is depicted. As shown, cloud computing environment 50 comprises one or more cloud computing nodes 30 with which local computing devices used by cloud consumers, such as, for example, personal digital assistant (PDA) or cellular telephone 23, desktop computer 21, laptop computer 22, and event such as OEM vehicle sensor data source 14, application data source 16, telematics data source 20, wireless infrastructure data source 17, and third party data source 15 and/or automobile computer systems such as vehicle data source 12. Nodes 30 can communicate with one another. They can be grouped (not shown) physically or virtually, in one or more networks, such as private, community, public, or hybrid clouds as described herein, or a combination thereof. The cloud computing environment 50 is configured to offer infrastructure, platforms and/or software as services for which a cloud consumer does not need to maintain resources on a local computing device. It is understood that the types of computing devices shown in FIG. 9 are intended to be illustrative only and that computing nodes 30 and cloud computing environment 50 can communicate with any type of computerized device over any type of network and/or network addressable connection (e.g., using a web browser).

Referring now to FIG. 9, a set of functional abstraction layers provided by cloud computing environment 50 (FIG. 8) is shown. The components, layers, and functions shown in FIG. 9 are illustrative, and embodiments as described herein are not limited thereto. As depicted, the following layers and corresponding functions are provided:

A hardware and software layer 60 can comprise hardware and software components. Examples of hardware components include, for example: mainframes 61; servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management so that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment can be utilized. Examples of workloads and functions that can be provided from this layer include mapping and navigation 91; ingress processing 92, stream processing 93; portal dashboard delivery 94—same number; data analytics processing 95; and egress and data delivery 96.

Although this disclosure describes embodiments on a cloud computing platform, implementation of embodiments as described herein are not limited to a cloud computing environment.

Embodiments described with respect to systems 10, 50, 100, 200, 400, 500, 600 and 700 described in conjunction with FIGS. 1-9, can be implemented by and/or executed on a single network computer. In other embodiments, these processes or portions of these processes can be implemented by and/or executed on a plurality of network computers. Likewise, in at least one embodiment, processes described with respect to systems 10, 50, 100, 200, 400, 500 and 600, or portions thereof, can be operative on one or more various combinations of network computers, client computers, virtual machines, or the like can be utilized. Further, in at least one embodiment, the processes described in conjunction with FIGS. 1-9 can be operative in system with logical architectures such as those also described in conjunction with FIGS. 1-9.

It will be understood that each block of the flowchart illustration, and combinations of blocks in the flowchart illustration, can be implemented by computer program instructions. These program instructions can be provided to a processor to produce a machine, such that the instructions, which execute on the processor, create means for implementing the actions specified in the flowchart block or blocks. The computer program instructions can be executed by a processor to cause a series of operational steps to be performed by the processor to produce a computer-implemented process such that the instructions, which execute on the processor to provide steps for implementing the actions specified in the flowchart block or blocks. The computer program instructions can also cause at least some of the operational steps shown in the blocks of the flowchart to be performed in parallel. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the disclosure.

Accordingly, blocks of the flowchart illustration support combinations for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments.

1. A system comprising a non-transitory memory including program instructions and a processor configured to execute instructions to at least:
ingress via an ingress server, an ingressed datastream of vehicle event data including movement data for a plurality of vehicles;
assign a plurality of Vehicle Identifiers to a plurality of respective vehicle records for the plurality of vehicles of the vehicle event data; and
egress a throttled datastream of the vehicle records to a client device via an egress server with a filterless throttling algorithm configured to sort a portion the vehicle records identified from the ingressed datastream to be egressed to the client device into a plurality of Bucket files and delete the vehicle records from the egress server that are not sorted to the plurality of Bucket files.

2. The system of claim 1, wherein the system further comprises a data storage configured to store vehicle event data, and wherein the filterless throttling algorithm is configured to at least:
obtain a Total Vehicles number by determining a total number of vehicles of the vehicle event data stored by the system for a predetermined time period;
identify a Total Buckets number for the total number of Bucket files to sort a portion of the vehicle records from the vehicle event data to be egressed to the external client device;
calculate a Vehicles Per Bucket by dividing the Total Vehicles number by Total Buckets number;
calculate a Vehicle Target number for the number of vehicle records to be egressed to the external client device;
calculate a Required Buckets by dividing the Vehicle Target number by the Vehicles Per Bucket number;
calculate a Vehicle Identifier Hash by hashing the Vehicle Identifier to a positive number;
calculate a Vehicle Bucket number by taking a Modulus of the Vehicle Identifier Hash by the Total Buckets number; and
if the Vehicle Bucket number is less than or equal to the Required Buckets number, include the vehicle record for the identified vehicle in the Vehicle Bucket file and egress the vehicle record via an egress server to the client device; or
if the Vehicle Bucket number is greater than the Required Buckets number, delete the vehicle record from the Egress Server.

3. The system of claim 2, wherein the filterless throttling algorithm is further configured to at least: calculate a Vehicle Target by calculating and adding a Minimum Additional Percentage of vehicles to the Total Vehicles.

4. The system of claim 3, wherein the filterless throttling algorithm is further configured to at least:
periodically recalculate the Vehicle Bucket to adjust for fluctuating volumes of vehicles identified from the vehicle event data, the recalculating comprising:
recalculating the Vehicles per Bucket;
recalculating the Vehicle Target; and
recalculating the Vehicle Bucket.

5. The system of claim 3, wherein the filterless throttling algorithm is further configured to at least:
precalculate the Vehicle Bucket for the vehicle event record, the precalculating comprising:
precalculating the Vehicles per Bucket;
precalculating the Vehicle Target; and
precalculating the Vehicle Bucket.

6. The system of claim 2, wherein the filterless throttling algorithm is configured to calculate the hash with a partition algorithm.

7. The system of claim 1, wherein the filterless throttling algorithm is configured to throttle the throttled datastream based on the external client system requirements.

8. The system of claim 1, wherein the egress server is configured to throttle the throttled datastream for stream delivery, batch delivery, or both.

9. A method to be executed on a system comprising a non-transitory memory including program instructions and a processor configured to execute instructions for a method, the method comprising:
ingressing, via an ingress server, an ingressed datastream of vehicle event data including movement data for a plurality of vehicles;
assigning a Vehicle Identifier for each of a plurality of vehicle records for the plurality of vehicles of the vehicle event data; and
egressing a throttled datastream of the vehicle records to a client device via an egress server with a filterless throttling algorithm configured to sort a portion the vehicle records identified from the ingressed datastream to be egressed to the client device into a plurality of Bucket files and deleting vehicle records not sorted to the plurality of buckets.

10. The method of claim 9, wherein the method further comprises:
obtaining a Total Vehicles number by determining a total number of vehicles of the vehicle event data stored by the system for a predetermined time period;
identifying a Total Buckets number for the total number of Bucket files to sort a portion of the vehicle records from the vehicle event data to be egressed to the external client device;
calculating a Vehicles Per Bucket by dividing the Total Vehicles number by Total Buckets number;
calculating a Vehicle Target number for the number of vehicle records to be egressed to the external client device;
calculating a Required Buckets by dividing the Vehicle Target number by the Vehicles Per Bucket number;
calculating a Vehicle Identifier Hash by hashing the Vehicle Identifier to a positive number;
calculating a Vehicle Bucket number by taking a Modulus of the Vehicle Identifier Hash by the Total Buckets number; and
if the Vehicle Bucket number is less than or equal to the Required Buckets number, include the vehicle record for the identified vehicle in the Vehicle Bucket file and egress the vehicle record via an egress server to the client device; or
if the Vehicle Bucket number is greater than the Required Buckets number, delete the vehicle record from the Egress Server.

11. The method of claim 10, wherein the method further comprises:
configuring a Minimum Additional Percentage of identified vehicles to add to the Total Vehicles; and
calculating the Vehicle Target by calculating and adding a Minimum Additional Percentage of vehicles to the Total Vehicles.

12. The method of claim 11, wherein the method further comprises:
periodically recalculate the Vehicle Bucket to adjust for fluctuating volumes of vehicles identified from the vehicle event data, the recalculating comprising:
recalculating the Vehicles per Bucket;
recalculating the Vehicle Target; and
recalculating the Vehicle Bucket.

13. The method of claim 11, wherein the method further comprises:
precalculate the Vehicle Bucket for the vehicle event record, the precalculating comprising:
precalculating the Vehicles per Bucket;
precalculating the Vehicle Target; and
precalculating the Vehicle Bucket.

14. The method of claim 10, wherein the method further comprises calculating the hash with a partition algorithm.

15. The method of claim 9, wherein the method further comprises: throttling the throttled datastream based on the external client system requirements.

16. The method of claim 9, the method further comprises: throttling the throttled datastream for stream delivery, batch delivery, or both.
